(19) United States
(12) Patent Application Publication
(10) Pub. No.: US 2025/0304376 A1
(43) Pub. Date: Oct. 2, 2025

(54) SYSTEMS AND METHODS FOR SOLAR PANEL ORIENTATION DURING A LOADING PROCESS ONTO A CENTRALIZED ASSEMBLY FRAMEWORK

(71) Applicant: Terabase Energy, Inc., Berkeley, CA (US)

(72) Inventors: Cedric Boss, Richmond, CA (US); Keisuke Shono, West Sacramento, CA (US); Adam Hansel, Davis, CA (US)

(73) Assignee: Terabase Energy, Inc., Berkeley, CA (US)

(21) Appl. No.: 18/623,140

(22) Filed: Apr. 1, 2024

(51) Int. Cl. B65G 17/12; B65G 61/00; B65G 65/00; H02S 30/10

(52) U.S. Cl. CPC B65G 17/12; B65G 61/00; B65G 65/00; B65G 2201/022; H02S 30/10

(57) ABSTRACT

A system for centralized assembly of a solar table is described in which a solar panel is autonomous or semi-autonomously removed from a crate and oriented in such a manner to allow loading the solar panel on an assembly framework with proper alignment is achieved. In some embodiments, a flipping station is used to enable this alignment. In other embodiments, a robotic arm is used with sufficient rotation and movement functionality to allow this alignment.

### TECHNICAL FIELD

The present disclosure relates generally to a centralized solar table assembly factory that supports solar panel orientation procedures that enable the solar panel to be loaded with proper alignment onto an assembly framework within the factory. More particularly, the present disclosure relates to different embodiments in which either a flipping station is implemented or a robotic arm having sufficient rotation and movement functionality is provided to allow these orientation procedures to occur.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge in this transition is the reduction in the high cost of installing these solar systems.

Large-scale solar panel systems typically include thousands of solar panels that are located across a multi-acre terrain and that are electrically coupled to provide a source of energy. These large-scale systems are oftentimes located in remote areas and require a significant investment in materials, resources and labor in their installation and design. The sourcing and delivery of materials and resources for these installations can be problematic and inconsistent. A further complication is the reliability of a deployed workforce to these remote areas and the high turnover of labor during the installation process. These issues further contribute to an increase in the cost and complexity of what is already a very cost-sensitive process. In order to reduce cost in the construction of these large-scale systems, the use of automation can help reduce costs as well as provide an alternative to at least some of the deployed workforce that is used in prior art systems.

FIG. 1 illustrates a typical prior-art installation process for solar systems. This prior art installation process is implemented such that all mounting equipment for each solar panel is individually assembled and installed at its location within the larger system. The cost-effectiveness of this approach works fine within smaller solar deployments but struggles to cost-effectively scale to large solar systems as described below.

This traditional deployment 101 relies on materials being delivered to a deployment site via an access road. The materials are then processed and staged at the deployment site by a crew. A small portion of this delivered material is then moved by heavy equipment to a specific location where a solar panel and mounting equipment are assembled and installed at that location 102. The step is then repeated for an adjacent location 103 where materials are subsequently delivered, assembled and installed for a neighboring solar table within the system. While this approach may be effectively deployed in the installation of smaller solar systems, it becomes cost-prohibitive as the size of the system increases.

This time and labor-intensive process is further complicated by the inconsistent delivery of material and components over the entire installation process as well as reliability issues of the workforce deployed to install the solar panel system. One skilled in the art will recognize that delays or complications within such a serial installation process will introduce subsequent costs and delays in other downstream processes within the installation.

What is needed are systems, devices and methods that reduce the complexity and cost of the installation of large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures may be not to scale.

FIG. 1 shows a prior art assembly and installation process of large-scale solar panel systems.

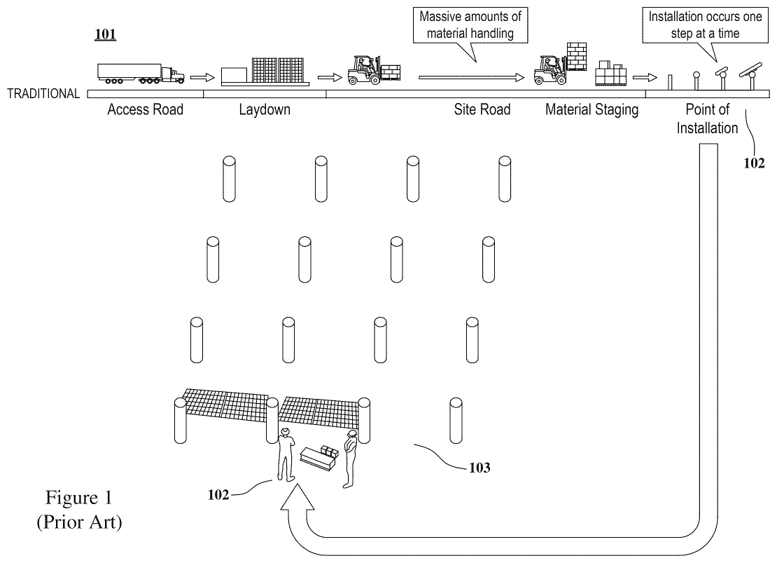

FIG. 2 is a diagram showing a centralized assembly and installation of a solar system in accordance with various embodiments of the invention.

FIG. 3 is a high overview of a system that assembles a solar table at a centralized assembly location and subsequent movement of the assembled solar tables to a variety of different installation points in accordance with various embodiments of the invention.

FIG. 4 is a centralized assembly system comprising an assembly framework, a robotic solar panel loader and a solar panel alignment flipping station in accordance with various embodiments of the invention.

FIG. 5 is a first embodiment of a slipper that holds a crate on which a plurality of solar panels located in accordance with various embodiments of the invention. This crate may be used by a solar panel supplier or may be used by an entity constructing the large-scale solar system to load a crate of solar panels prior to assembly.

FIG. 6 is a first example of a crate with a plurality of solar panels positioned on a slipper in accordance with various embodiments of the invention.

FIG. 7 is a second example of a crate with a plurality of solar panels positioned on a slipper in accordance with various embodiments of the invention.

FIG. 8 is a third example of a crate with a plurality of solar panels positioned on a slipper in accordance with various embodiments of the invention.

FIG. 9 is a fourth example of a crate with a plurality of solar panels positioned on a slipper in accordance with various embodiments of the invention.

FIG. 10 is an illustration of a centralized assembly framework having two solar panels loaded thereupon in accordance with various embodiments of the invention.

FIG. 11 is an illustration of a robotic arm used to load solar tables on a centralized assembly framework in accordance with various embodiments of the invention.

FIG. 12 is an exemplary solar panel orientation flipping station in accordance with various embodiments of the invention.

FIG. 13 is a centralized assembly framework and robotic arm that uses robotic joint(s) to align a front-facing solar panel to the assembly framework in accordance with various embodiments of the invention.

FIG. 14 is a centralized assembly framework and robotic arm that uses robotic joint(s) to align a back-facing solar panel to the assembly framework in accordance with various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method related to autonomous or semi-autonomous structure and functionality deployed within a centralized solar table assembly factory.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded.

Further, it shall be noted that: (1) certain steps may optionally be performed; (2) steps may not be limited to the specific order set forth herein; (3) certain steps may be performed in different orders; and (4) certain steps may be done concurrently.

Furthermore, it shall be noted that many embodiments described herein are given in the context of the assembly and installation of large numbers of solar tables within a system, but one skilled in the art shall recognize that the teachings of the present disclosure may apply to other large and complex construction sites in which resources and personnel are difficult to manage and accurately predict.

In this document, “large-scale solar system” refers to a solar system having 1000 or more solar panels. The word “resources” refers to material, parts, components, equipment or any other items used to construct a solar assembly and/or solar system. The word “personnel” refers to any laborer, worker, designer or individual employed to construct or design a solar table or solar system. The terms “orientation” or “orientate” refers to the movement and/or rotation of a solar panel by a robotic arm to a preferred forward-facing position (either backside or frontside forward-facing) and positioning of bottom edge, top edge and side edge(s) prior to be placed on an assembly framework. The terms “alignment” or “align” refers to the position of a properly oriented solar panel on the assembly framework. The term “robotic arm” refers to any robotic structure that can orientate and/or align a solar panel. The term “solar table” refers to a structural assembly comprising a torque tube and/or purlins with module rails. Some types of solar tables may have supplemental structure that allows it to connect to foundations/piles while other types do not have this supplemental structure.

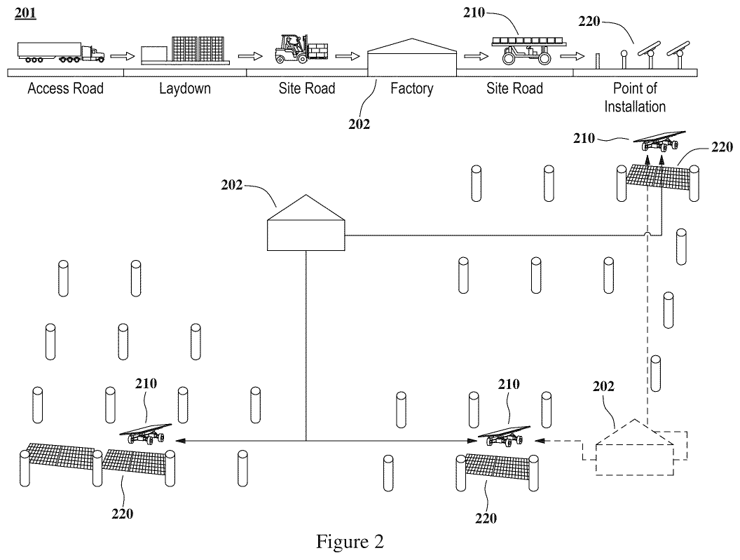

FIG. 2 provides an overview of a centralized solar table assembly and installation for large-scale solar systems according to various embodiments of the invention. Embodiments of the invention transition the prior art approach of assembly and installation at single location sites to a centralized and coordinated assembly factory that allows a more cost-effective and dynamic process of constructing large-scale solar systems. Additionally, embodiments of the invention provide an improved process of resource and personnel management during the construction process that improves cost and efficiency as conditions change at the construction site.

Resources are brought to construction site 201 for large-scale solar systems and initially processed. These resources are delivered to one or more assembly factories 202 where a coordinated and centralized solar table assembly process is performed. Detailed description of how the assembly process is automated and enhanced is provided later within this document. In addition, personnel management and efficiency improves as a larger portion of automation and assembly processes is centrally located and closer to resources needed for assembly of components within the large-scale solar system.

In certain embodiments, a construction site may have multiple centralized factories 202. The term “centralized” does not mean that a location is necessarily located at the center of a site, rather a centralized assembly factor may be located anywhere in or proximate to solar table installation sites within a large-scale solar system. As shown in FIG. 2, there are two centralized factories 202 strategically located within the site. The location and number of centralized factories 202 may depend on several parameters including the size of the site, the terrain of the site, the design of the site and other variables that relate to the construction of the large-scale solar system. For example, one skilled in the art will recognize that the characteristics of solar tables will vary across a large-scale system. The specific structural design of a solar table may depend on its relative location to the edge of a solar system, the specific terrain at which it is installed, the sun light conditions at its location and other parameters known to one of skill in the art. The construction process may be improved by including this solar table information in an assembly process and identifying one or more factory locations (and assembly processes therein) that take this information into account.

Assembled solar tables and equipment are moved from factory 202 to a point of installation 220 via motorized vehicles 210. In certain embodiments, the motorized vehicles are specifically designed to transport solar tables along a site road to the point of installation 220. The motorized vehicles 210 may be driven by personnel, may be controlled by remote control or autonomously driven by a computer system. The time and/or sequence in which solar tables are delivered to points of installation 220 may depend on a variety of factors that may be analyzed to configure a preferred schedule. This analysis will be described in more detail later within this document.

One skilled in the art will recognize the advantages in configurability and adaptability of the centralized assembly and installation processes relative to the serial point-by-point installation process of the prior art. Users can configure solar table assembly and delivery processes based on (1) the design and terrain of the large-scale solar systems, (2) the availability and delivery of resources used to construct the solar tables and other components within the systems, and (3) the work schedule and availability of personnel needed during the construction process. Additionally, users can adapt in real-time assembly and construction processes as these parameters change.

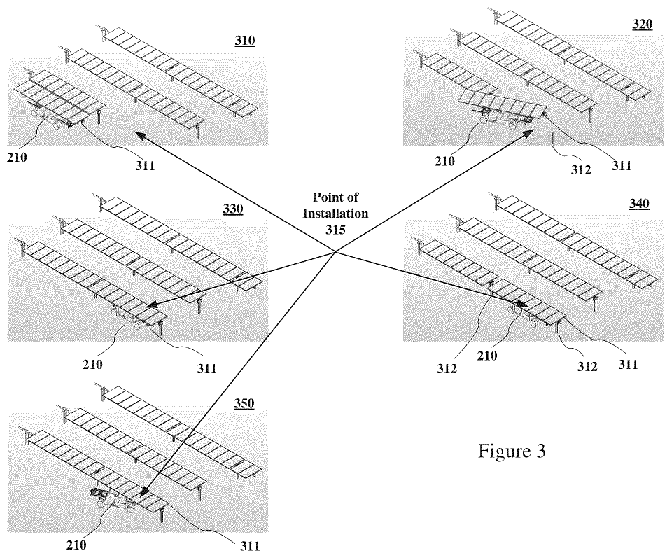

FIG. 3 illustrates a sequence of installation steps of a solar table at an installation site using a solar panel mobile transport according to various embodiments of the invention. As shown in 310, a mobile transport 210 supporting a solar table 311 approaches a point of installation 315. The solar table 311 is secured to the mobile transport 210 by a solar table attachment component that securely holds the solar table above the mobile transport 210. In certain embodiments, the solar table 311 is assembled and secured to the attachment component at a centralized assembly factory and subsequently driven to the point of installation 315.

As shown in 320, the mobile transport 210 approaches the point of installation 315 in preparation for installation within the solar system. The point of installation 315 comprises structures used to secure the solar table 311 within the system. For example, a solar table 312 may be secured to a previously installed table whereby a torque tube in the solar table 311 is inserted into a previously installed table. The previously installed table may be secured to a pile 312 where threaded fasteners/rivets connect its bearing housing assembly/brackets to the pile 312. As shown in 330, the mobile transport 210 aligns the solar table 311 at the installation point 315 for subsequent integration into solar system.

As shown in 340, the solar table is secured within the solar system after alignment is completed. This securitization process includes attaching the solar table 210 to piles 312 that lock the solar table in line with adjacent solar tables. One skilled in the art will recognize that other processes may be employed to securely lock a solar table 311 within the system and may use other components that replace or supplement the piles 312.

As shown in 350, mobile transport 210 detaches from the solar table 311 after an alignment process has occurred using horizontal, vertical and angular control as needed. The solar table 311 is lowered and secured within the system so that the mobile transport 210 may leave the point of installation 315.

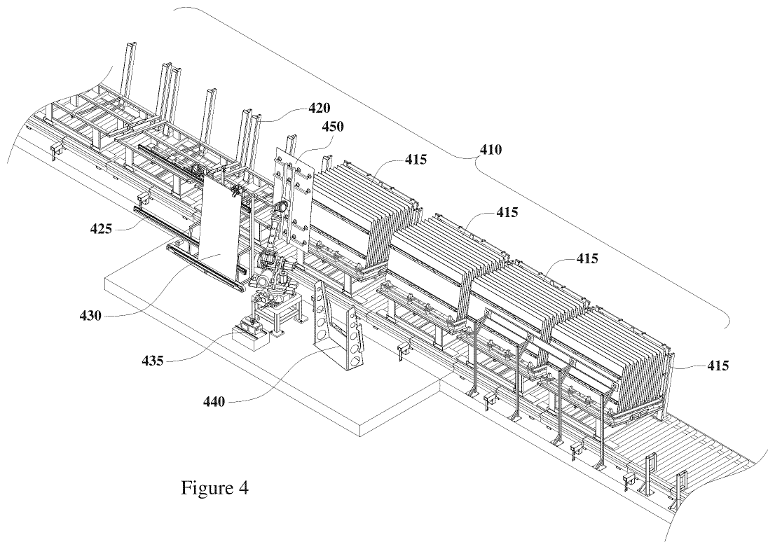

FIG. 4 illustrates an exemplary centralized assembly factory 410 according to various embodiments of the invention. As shown, assembly factory 410 comprises an assembly framework 425 having multiple rails that guide and move solar panels and/or solar tables. The assembly framework 425 also allows solar panel coupling to a torque tube during the assembly of a solar table is performed. In certain embodiments, solar panels are loaded onto the assembly framework 425 using a robotic arm 435 and a flipping station 440 that allows solar tables to be properly orientated and aligned on the framework 425 after the loading process. In other embodiment, the robotic arm 435 does not use a flipping station 440, but rather has one or more motors that allow the robotic arm 435 to couple to solar panels (that may be shipped in different crates, which may have different orientations of the solar panels located thereon) and adjust an orientation of a solar panel so that it is properly aligned on the rails of the assembly framework 425. These different embodiments and loading processes are described in more detail later.

In certain embodiments, a crate is initially loaded onto a slipper 420 that provides a backward tilt of the crate and solar panels to reduce the frequency of solar tables falling of a crate during the assembly process. A slipper 420 with a solar panel crate 415 are positioned on a crate guide 410 that allows movement of the slipper 420 and crate 415 along an axis and proximate to the assembly framework 425, the robotic arm 435 and, in some embodiments, the flipping station 440. These different embodiments of the invention allow a robotic arm 435 to couple to solar panels that are stored in different orientations on crates, orient the solar panel to a proper position, and load the solar panel with an appropriate alignment onto an assembly framework 425.

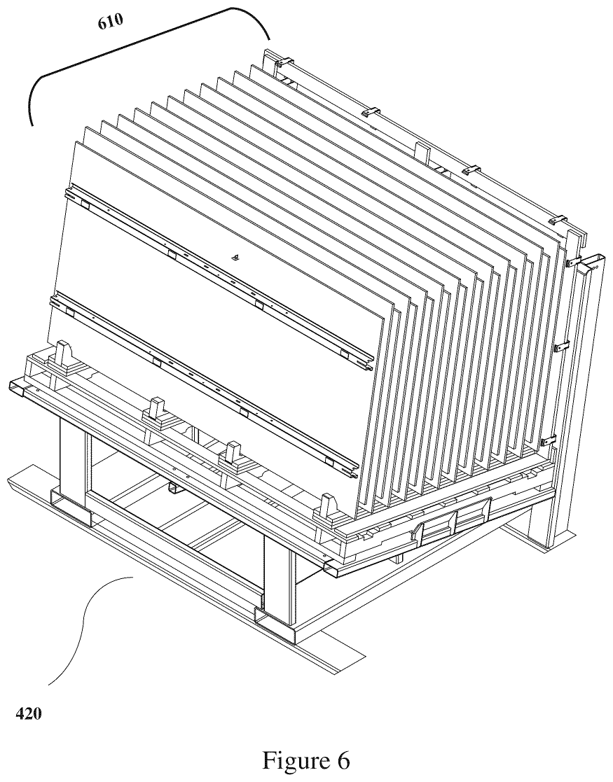

An automated or partially automated process of loading solar panels onto assembly framework 425 occurs as described below in accordance with various embodiments of the invention. Crates holding solar panels are loaded on to slippers 420 in preparation for assembly into solar tables. As will be discussed relative to FIGS. 6-9, the orientation of solar panels on a crate may vary across different vendors. In a first embodiment, a slipper 420 and crate 415 are positioned at a first location proximate to a robotic arm 435. The robotic arm 435 couples to either a frontside or backside of a solar panel on the crate and physically removes the solar panel from the crate. If the orientation of the solar panel is not properly aligned to the assembly framework 425 (e.g., the backside is facing outwards), then the robotic arm 435 places the solar panel on the flipping station 440. The robotic arm 435 then decouples from the solar panel and recouples to the solar panel so that it may be placed in proper alignment (e.g., the frontside is facing outwards) on the assembly framework 425. This proper alignment will allow the solar panel to be used to construct a solar table during operation on assembly framework 425. One skilled in the art will recognize that alignment may vary across different embodiments. For example, in certain instances the solar panel frontside should be outward facing and in other instances the solar panel backside should be outward facing. In other examples, the solar panel side edge should be at the top of the assembly framework 425 and in yet other examples, the solar panel top edge should be at the top of the assembly framework 425. Proper alignment may also relate to both frontside/backside positioning and top/side edge positioning.

In other embodiments, proper alignment of a solar table is achieved without the use of a flipping station 440. For example, the robotic arm 435 may have one or more motors that allow for rotation, movement and orientation of the solar panel such that the appropriate side and edge are properly aligned on the assembly framework 425 without having to release the solar panel onto a flipping station. These different embodiments will be described later below after different components within embodiments of the centralized solar panel assembly factory are described.

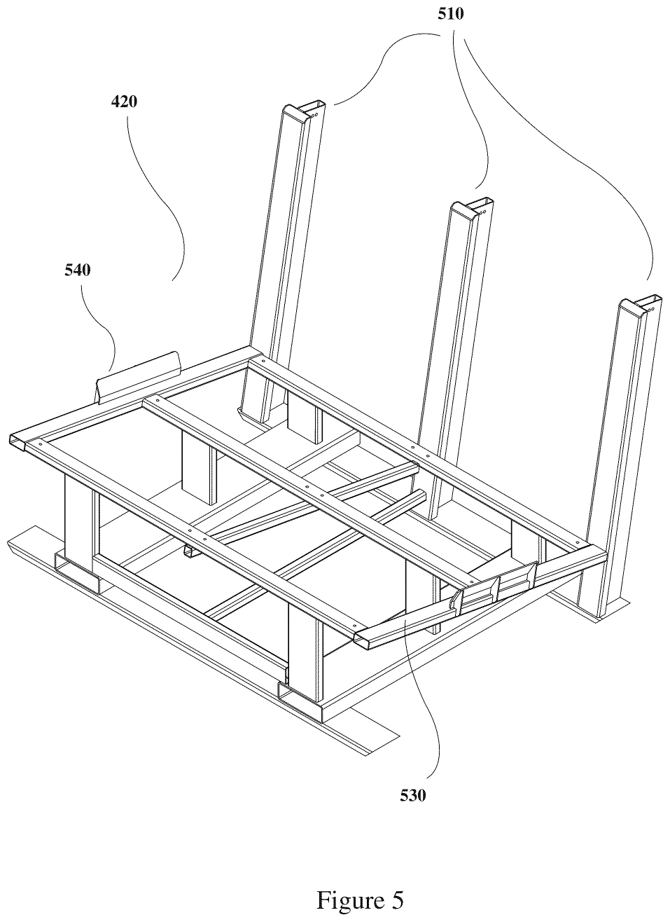

FIG. 5 illustrates a slipper according to various embodiments. As described above, certain embodiments of the invention allow a crate containing a plurality of solar panels to be placed upon a slipper to allow a more secure positioning of solar panels as they are assembled into solar tables within the centralized assembly factory. Slipper 420 comprises one or more bottom support(s) 530 on which a crate holding a plurality of solar panels rest. The bottom support(s) 530 may be a plurality of rails or a single slab to hold the crate. The bottom support(s) is angled backwards such that a slight gravity force on the solar panel pushes backwards to reduce instances of solar panels falling off the crate/slipper in a forward motion. Back support rails 510 prevent the crate from sliding backwards and off the slipper 420. Slipper 420 also comprises side guards 540 the reduce side-to-side movement of the crate when resting on the slipper 420. In certain embodiments, the side guards 540 structurally extend vertically above the bottom support(s) 530 such that the amount of movement of the crate is reduced.

One skilled in the art will recognize that the components of the slipper 420 described above may vary structurally/shape but substantially perform the associated functions. These functions relate to a more secured holding structure of a crate of solar panels as it is placed and moved within the centralized solar table assembly factory.

FIG. 6 illustrates a first example of a slipper holding a crate of solar panels according to various embodiments of the invention. As shown, slipper 420 supports a plurality of solar panels 610 that are shipped in a particular manner in which each solar panel is placed on a side edge and positioned front-to-back and back-to-front in a crate. As previously discussed, solar panel manufacturers ship crates full of solar panels in different ways that present issues in an autonomous process of loading a solar panel from the crate to assembly framework 425.

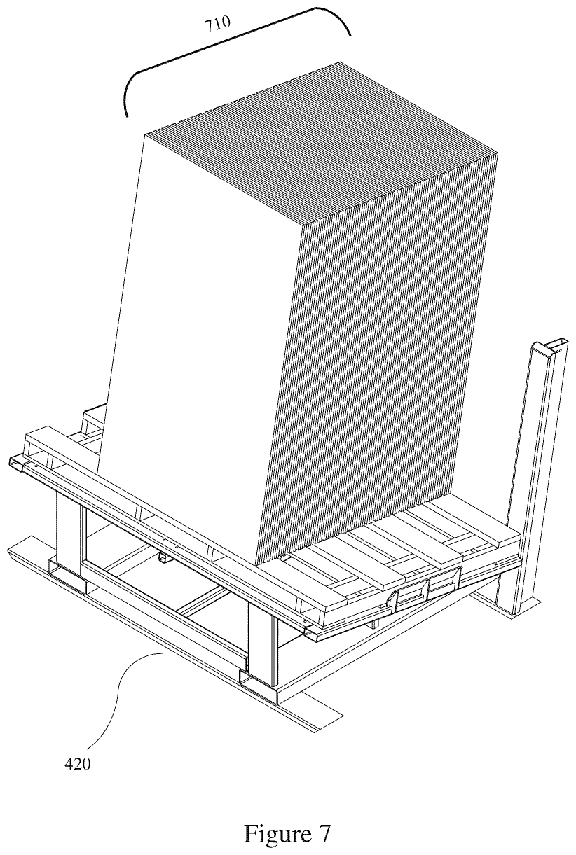

In certain embodiments, solar panels are placed forward-facing on rails within the assembly framework. However, in this instance the robotic arm 435 may only couple to the side of the solar panel that is outwardly facing from the crate. Prior art systems are unable to address this automation issue and require personnel to either load the panel or to rotate the panel on the crate to enable the robotic arm 435 to properly couple to the solar panel. FIGS. 7-9 illustrate other configurations of solar panels shipped in crates by different vendors.

FIG. 7 illustrates a second example of a slipper holding a crate of solar panels according to various embodiments of the invention. As shown, slipper 420 supports a plurality of solar panels 710 that are shipped where each solar panel is placed on a bottom edge with each front side of the panels forward-facing from the crate. As was the case in FIG. 6, this manner of positioning solar panels within a crate may create problems for autonomous loading of a solar panel from the crate to assembly framework 425.

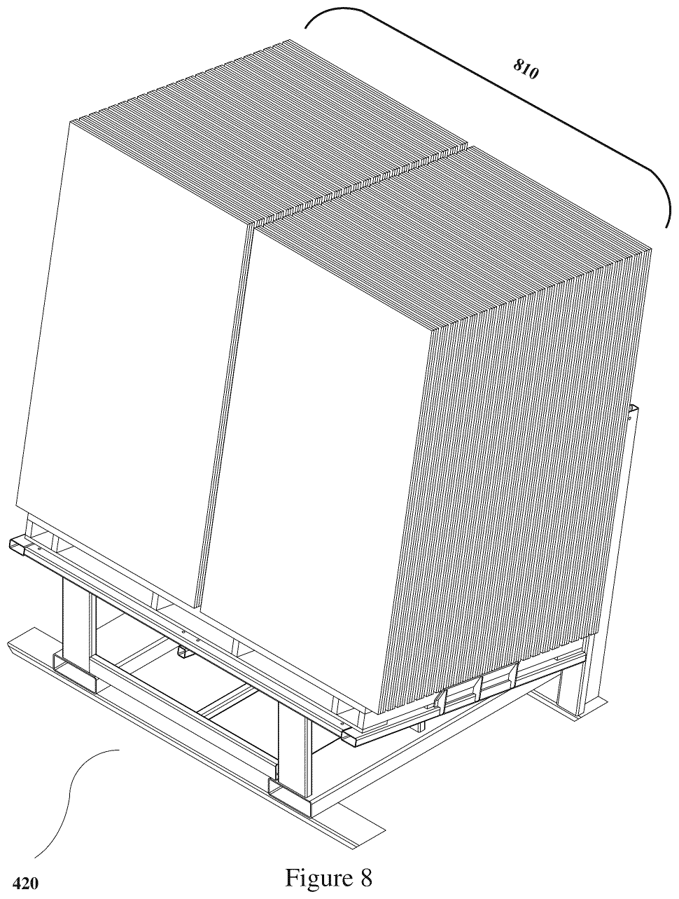

FIG. 8 illustrates a third example of a slipper holding a crate of solar panels according to various embodiments of the invention. As shown, slipper 420 supports a plurality of solar panels 810 that are shipped where solar panels are organized in two rows and each solar panel is placed on a bottom edge with each front side of the panels forward-facing from the crate. As was the case in FIGS. 6 and 7, this manner of positioning solar panels within a crate may create problems for autonomous loading of a solar panel from the crate to assembly framework 425.

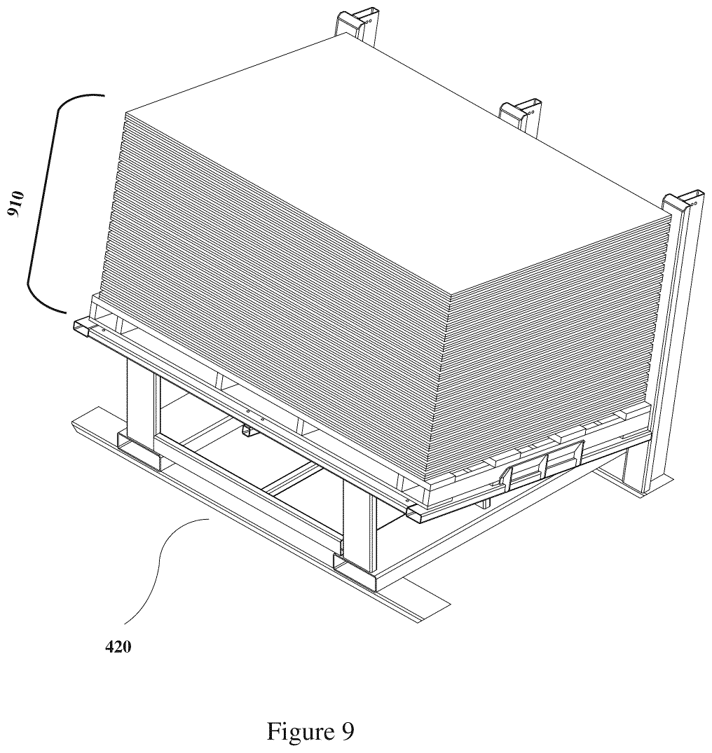

FIG. 9 illustrates a fourth example of a slipper holding a crate of solar panels according to various embodiments of the invention. As shown, slipper 420 supports a plurality of solar panels 910 that are shipped where the solar panels are stacked on top of each other with the front side facing upwards. As was the case in FIGS. 6-7, this manner of positioning solar panels within a crate may create problems for autonomous loading of a solar panel from the crate to assembly framework 425.

One skilled in the art will recognize that other solar panel shipping formations may exist and present issues for autonomous loading of a solar panel onto assembly framework 425. Various embodiments of the invention provide multiple solutions for this issue by either the use of a flipping station 440 or a robotic arm 435 having a joint(s) that allows dynamic movement of the arm to adjust a solar panel during the loading process such that it is properly aligned on the assembly framework 425.

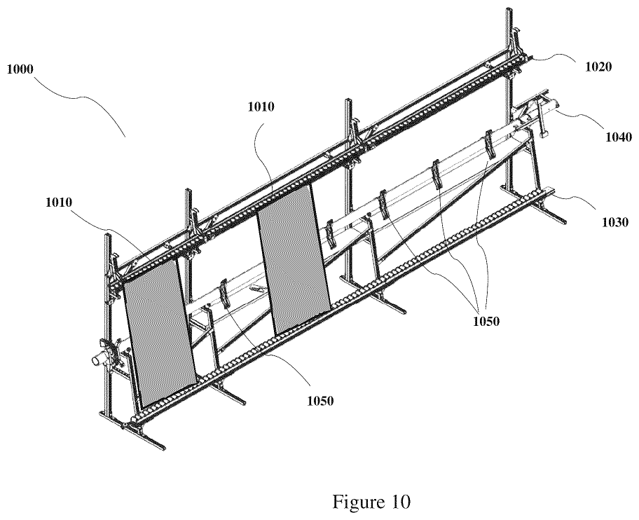

FIG. 10 illustrates an assembly framework on which solar panels are loaded so that a solar table may be created according to various embodiments of the invention. This figure illustrates one scenario in which the orientation of each solar panel positioned on the rails of the framework is important to the functioning of autonomous processes used in constructing the solar table. As shown, the assembly framework 1000 comprises a top rail 1020 and a bottom rail 1030 each with rollers that allow solar panels 1010 to move across the framework. In other embodiments, only one of the rails may have rollers. In yet other embodiments, other mechanism known to one of the skill in the art may be used instead of rollers. The assembly framework 1000 also supports a torque tube 1040 having multiple coupling elements 1050 that secures the torque tube 1040 to each of the solar panels 1010.

In this example, solar panels 1010 are loaded onto the framework 1000 with a frontside facing outward and a bottom edge resting on the bottom rail 1030 and a top edge being supported by the top rail 1020. Each solar panel can move horizontally across the framework to properly position it relative to a torque tube 1040 and/or coupling element 1050. After being properly positioned, an individual or autonomous process secures the coupling element 1050 to the backside of the solar panel 1010. The coupling element 1050 may be secured to solar panel 1010 using screws that are inserted into a rail(s) on the backside of the solar panel 1010. One skilled in the art will recognize that this is one example of an assembly process and that other examples are supported by other embodiments of the example.

If a solar panel is loaded onto the framework 1000 with its backside facing forward or a side edge resting on the bottom rail 1030, then an individual is needed to physically reorient and align the solar panel to a proper alignment. In such a scenario, some of the benefits provided by autonomous processes are lost and the time and cost required to assemble a solar table may increase due to the non-autonomous step within the process.

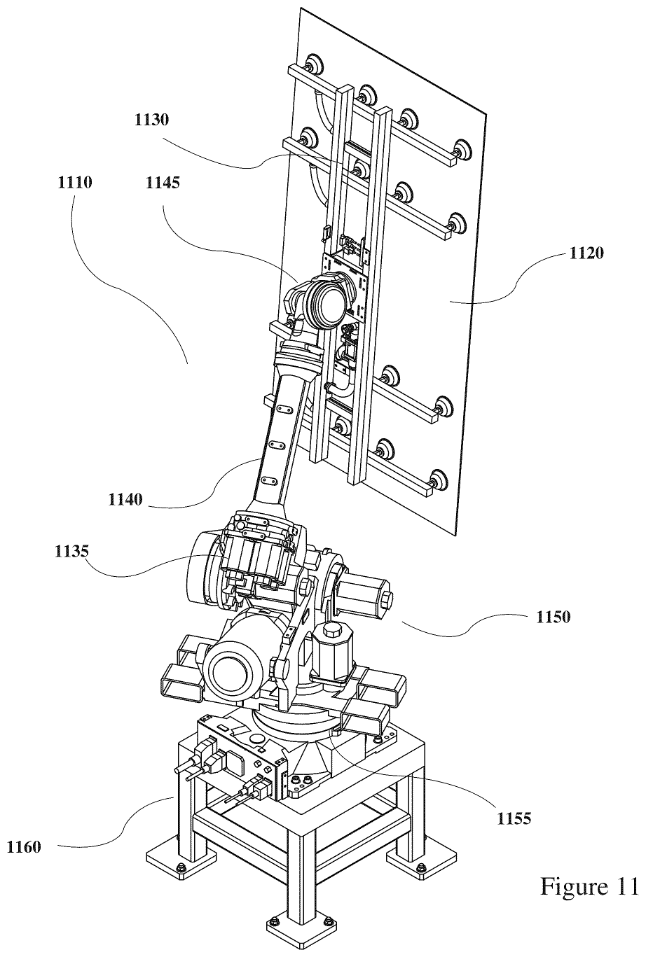

FIG. 11 illustrates a robotic arm used within a centralized solar table assembly factory according to various embodiments of the invention. The robotic arm 1110 comprises a base 1160 that supports the arm, a plurality of motors that allow three-dimensional movement in x, y, z planes and a plurality of rotational movements around different axes. The robotic arm 1110 also includes an extending rod 1140 and a solar panel coupling element. In this example, the solar panel coupling element comprises a plurality of suction cups positioned across different rods, the suction cups secure the robotic arm 1110 to a solar panel 1120. One skilled in the art will recognize that other structures may be used to secure the solar panel 1120 to the robotic arm 1110 including but not limited to clamp(s), claw(s) and other devices that can be secured to rails on the solar panel 1120.

Robotic arm 1110 can remove a solar panel from a crate and initiate a loading process onto the assembly framework. In a first embodiment, the loading process may comprise an intermediary step in which the solar panel is placed on a flipping station 440 and decoupled from the robotic arm 1110. The robotic arm 1110 is then recoupled to the solar panel 1120 at a different location/side of the solar table and then loaded onto the assembly framework with the correct alignment. In this embodiment, the robotic arm 1110 does not have sufficient movement or rotation to allow full orientation of the solar table 1120 such that proper alignment is not possible without using the flipping station 440. In other embodiments, robotic arm 1110 has sufficient movement and rotation capabilities to allow the robotic arm 1110 to orient the solar table 1120 in a manner such that proper alignment is achieved without using the flipping station 440.

In certain embodiments, base 1160 comprises legs or a structure that can be secured to a floor of the centralized solar table assembly factory and functions to stabilize the robotic arm during operation. The robotic arm 1100 comprises a first motor 1155 that provides rotation around a vertical axis such that control is provided that allows for the solar table 1120 to be oriented in a front-facing forward position or a back-facing forward position on the assembly framework 1000. In various embodiments, the first motor 1115 may include any motor that provides this functionality and that is understood by one of skill in the art.

The robotic arm 1100 may comprise a second motor 1150 that provides vertical movement of the solar table 1120 to allow proper alignment during a loading process. In various embodiments, the second motor 1120 may include any motor that provides this functionality and that is understood by one of skill in the art. A third motor 1135 provides a second rotational movement around an axis that may move depending on movement of other motors on the robotic arm 1110. In various embodiments, the third motor 1135 may include any motor that provides this functionality and that is understood by one of skill in the art.

The robotic arm 1100 may also comprise an extending rod 1140 that positions the solar table 1120 a distance away from the base 1160. In certain embodiments, the extending rod 1140 is a fixed length. In other embodiments, the extending rod 1140 has an associated motor that extends or shortens the extending rod 1140 during an orientation process of the solar table 1120. In various embodiments, the associated motor may include any motor that provides this functionality and that is understood by one of skill in the art.

In various embodiments, the robotic arm 1110 may comprise a fourth motor proximate to the solar table 1120 that provides finer movements and rotations that may be used during a loading process. In some examples, the rotations may be performed in relation to a horizontal axis, a vertical axis, and/or a combination thereof. Also, some examples include movements in an x direction, a y direction, and/or a combination thereof. In various embodiments, the fourth motor may include any motor that provides this functionality and that is understood by one of skill in the art.

The robotic arm 1110 may also include coupling elements 1130 that couple to a solar table 1120 in accordance with various embodiments of the invention. In certain embodiments, the coupling elements 1130 comprises a plurality of suction cups that allow coupling to a frontside or backside of a solar table 1120. In other embodiments, the coupling elements 1130 comprises clamp(s), claw(s) and other devices that can be secured to rails on the solar panel so that the robotic arm 1110 to couple to a backside of a solar table 1120. One skilled in the art will recognize that the process of securing the robotic arm 1110 to the solar table may be an automated process, a manual process, or a combination thereof.

One skilled in the art will also recognize that not all these components may be required to perform orientation processes of solar tables to enable proper alignment during a loading process on the assembly framework 1000.

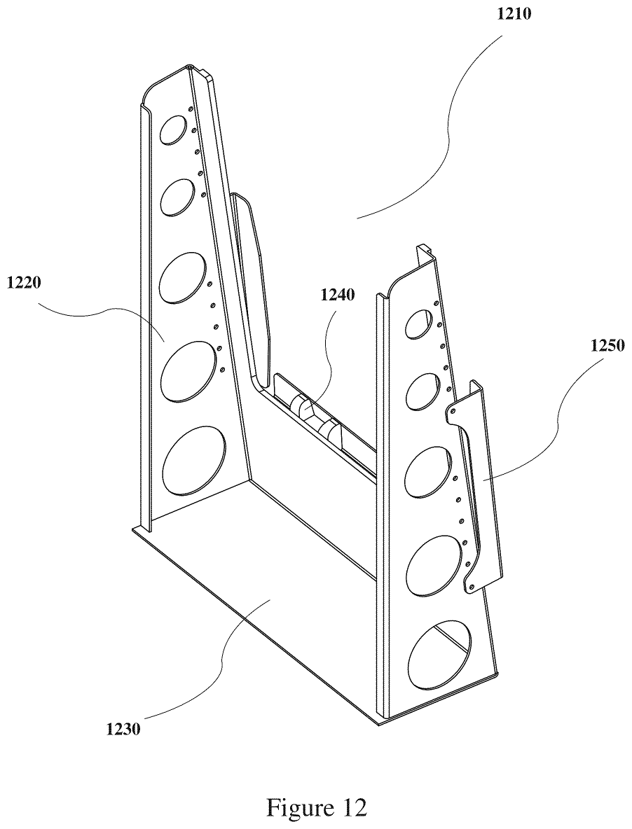

FIG. 12 illustrates an exemplary flipping station according to various embodiments of the invention. In this example, the flipping station 1210 comprises a base 1230, side components 1220, a side stabilizer 1250 and a holding element 1240 on which a solar table can rest. One skilled in the art will recognize that the flipping station 1210 may vary structurally so long as it provides the functionality described in the next paragraph.

Flipping station 1210 provides a structure that will allow the robotic arm 1110 to position and release a solar table, hold the solar table for a period of time and allow the robotic arm 1110 to recouple to the robotic arm 1110. The flipping station 1210 provides access to surface area of the solar table or rails on the solar table such that the recoupling process allows the robotic arm 1110 to complete an orientation procedure so that a loading process may be completed with correct alignment of the solar table on the assembly framework 1000. The flipping station 1210 may comprise any structural design that allows this decoupling and recoupling described procedures.

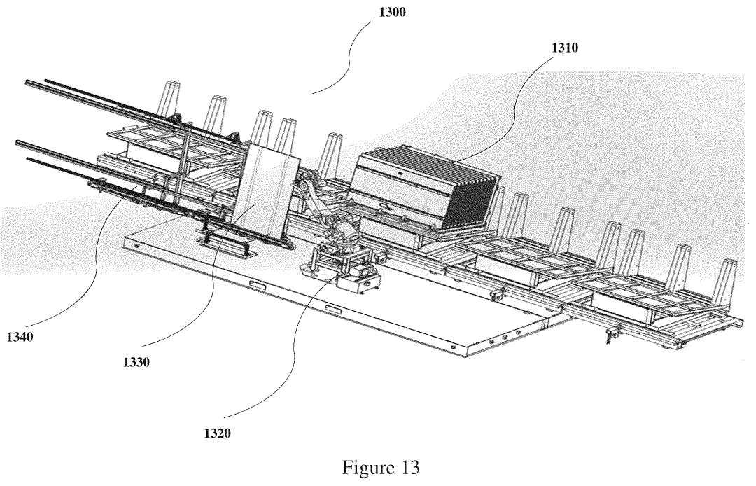

FIG. 13 illustrates a first example of a centralized solar table assembly factory in accordance with various embodiments. In this example, centralized solar table assembly factory 1300 comprises a robotic arm 1320 and an assembly framework 1340. However, a flipping station is not required due to the rotations and movements available on the robotic arm 1320 such that a solar panel 1310 may be properly orientated so that loaded on the assembly framework 1340 with the correct alignment. A properly aligned solar panel 1330 may be used in the assembly of a solar table.

In this example, the robotic arm 1320 couples to a backside of the solar panel 1330 according to various embodiments. The robotic arm 1320 provides sufficient rotation and such that it is loaded on the assembly framework 1340 in a frontside, forward facing position with a bottom edge located on a bottom rail.

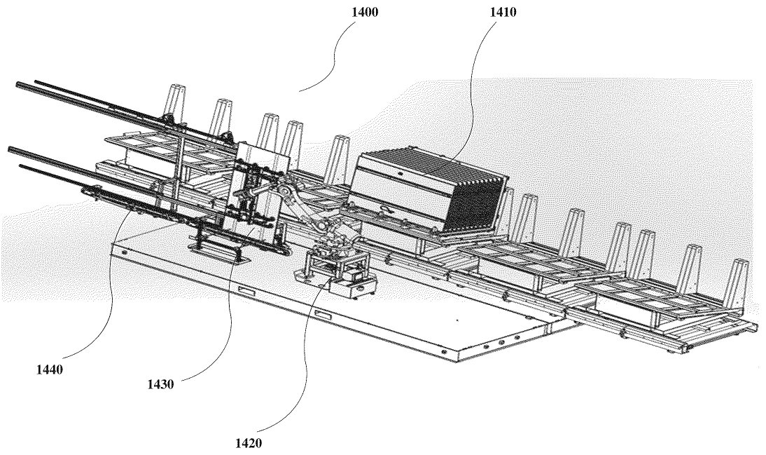

FIG. 14 illustrates a second example of a centralized solar table assembly factory in accordance with various embodiments. In this example, centralized solar table assembly factory 1400 comprises a robotic arm 1420 and an assembly framework 1440. However, a flipping station is not required due to the rotations and movements available on the robotic arm 1420 such that a solar panel 1410 may be properly orientated so that loaded on the assembly framework 1440 with the correct alignment. A properly aligned solar panel 1430 may be used in the assembly of a solar table.

In this example, the robotic arm 1420 couples to a frontside of the solar panel 1430 according to various embodiments. The robotic arm 1420 provides sufficient rotation and such that it is loaded on the assembly framework 1440 in a frontside, forward facing position with a bottom edge located on a bottom rail.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A system for orientating and loading a solar panel within a centralized solar table assembly factory, the system comprising:
a crate guide that supports at least one of a slipper and a crate holding a plurality of solar panels;
a robotic arm located proximate to the crate guide such that the robotic arm may couple to a solar panel within the plurality of solar panels, the robotic comprising:
a base that is secured to a floor of the centralized solar table assembly factory;
an extending rod coupled to the base, the extending rod extends away from the base;
a securing element coupled to the extending rod, the securing element couples to a first side of the first solar panel; and
a plurality of motors coupled within the robotic arm, the plurality of motors control movement of the extending rod and the securing element to provide rotational motion and movement within an x, y and z planes to enable proper orientation of the first solar panel; and
an assembly framework located proximate to the robotic arm, the assembly framework comprising a top rail and a bottom rail that supports a properly aligned solar panel being loaded by the robotic arm.

2. The system of claim 1 wherein the crate guide supports the slipper holding the crate and wherein the crate contains the plurality solar panels in a predefined sequence and orientation.

3. The system of claim 1 wherein the robotic arm provides the rotation motion and movement that allows the first solar panel to be loaded onto the assembly framework from a frontside, forward-facing aligned position.

4. The system of claim 3 wherein the robotic arm provides the rotation motion and movement that allows the first solar panel to be loaded onto the assembly framework wherein a top edge of first solar panel rests on the top rail.

5. The system of claim 1 wherein the robotic arm provides the rotation motion and movement that allows the first solar panel to be loaded onto the assembly framework from a backside, forward-facing aligned position.

6. The system of claim 1 wherein a first motor, within the plurality of motors, provides vertical movement of the securing element.

7. The system of claim 1 wherein a second motor, within the plurality of motors, provides horizontal movement of the securing element.

8. The system of claim 1 wherein a third motor, within the plurality of motors, provides rotational motion of the securing element.

9. The system of claim 1 wherein a fourth motor, coupled within the plurality of motors, provides movement to enable a frontside, forward-facing orientation of the first solar panel and a backside, forward-facing orientation of the first solar panel.

10. The system of claim 1 wherein the securing element comprises a plurality of suction cups that couple to a glass surface of the first solar panel.

11. The system of claim 10 wherein the glass surface is on a frontside of the first solar panel.

12. The system of claim 10 wherein the glass surface is on a backside of the first solar panel.

13. The system of claim 1 wherein the securing element comprises at least one of a clamp, claw and other device that can be secured to rails on the first solar panel.

14. A system for orientating and loading a solar panel within a centralized solar table assembly factory, the system comprising:
a crate guide that supports at least one of a slipper and a crate holding a plurality of solar panels;
a robotic arm located proximate to the crate guide such that the robotic arm may couple to a solar panel within the plurality of solar panels, the robotic comprising:
a base that is secured to a floor of the centralized solar table assembly factory;
an extending rod coupled to the base, the extending rod extends away from the base;
a securing element coupled to the extending rod, the securing element couples to a first side of the first solar panel; and
a plurality of motors coupled within the robotic arm, the plurality of motors control movement of the extending rod and the securing element;
a flipping station that is positioned proximate to the robotic arm, the flipping station allows the robotic arm to decouple from the first solar panel, support the decoupled first solar panel, and enable the robotic arm to recouple to the first solar panel to enable proper orientation of the first solar panel; and
an assembly framework located proximate to the robotic arm, the assembly framework comprising a top rail and a bottom rail that supports a properly aligned solar panel being loaded by the robotic arm.

15. The system of claim 14 wherein the securing element comprises a plurality of suction cups that couple to a glass surface of the first solar panel.

16. The system of claim 15 wherein the glass surface is on a frontside of the first solar panel.

17. The system of claim 15 wherein the glass surface is on a backside of the first solar panel.

18. The system of claim 14 wherein the securing element comprises at least one of a clamp, claw and other device that can be secured to rails on the first solar panel.

19. The system of claim 14 wherein the crate guide supports the slipper holding the crate and wherein the crate contains the plurality solar panels in a predefined sequence and orientation.

20. The system of claim 14 wherein the decoupling and recoupling of the securing element to the first solar panel enables a frontside, forward-facing orientation of the first solar panel or a backside, forward-facing orientation of the first solar panel.
